(19) United States
(12) Patent Application Publication
(10) Pub. No.: US 2011/0315764 A1
(43) Pub. Date: Dec. 29, 2011

(54) CODE READING APPARATUS AND CODE READING METHOD

(75) Inventor: Kazufumi Suzuki, Shizuoka (JP)

(73) Assignee: TOSHIBA TEC KABUSHIKI KAISHA, Tokyo (JP)

(21) Appl. No.: 13/170,240

(22) Filed: Jun. 28, 2011

(30) Foreign Application Priority Data
Jun. 29, 2010 (JP) 2010-148055

(51) Int. Cl. G06K 15/00

(52) U.S. Cl. 235/383

(57) ABSTRACT

A code reading apparatus includes: a photographing section configured to photograph an image; a capturing section configured to capture the photographed image; a reading section configured to detect, out of the captured image, a code symbol that represents commodity information indicating a purchase target commodity and benefit indication that represents benefit information indicating a benefit for the purchase of the commodity and read, from the detected code symbol and benefit indication, the commodity information represented by the detected code symbol and the benefit information represented by the detected benefit indication; a determining section configured to determine, if plural kinds of the benefit information are read, from benefits indicated by the plural kinds of the benefit information, a benefit granted for the purchase of the commodity indicated by the read commodity information; and an output section configured to output the read commodity information and benefit information representing the determined benefit.

### CROSS-REFERENCE TO RELATED APPLICATIONS

This application is based upon and claims the benefit of priority from the prior Japanese Patent Application No. 2010-148055, filed on Jun. 29, 2010; the entire contents of which are incorporated herein by reference.

### FIELD

Embodiments described herein relate generally to a code reading apparatus and a code reading method.

### BACKGROUND

In the past, in order to reduce disposal losses of perishable foods, a retail store such as a supermarket often sells commodities at cut prices when the closing time approaches. In selling the commodities at cut prices, the store affixes price-cut or discount labels indicating price-cut amounts or discount rates to the commodities in order to clearly indicate to customers that the commodities are price-cut or discounted commodities.

When a price-cut or discount label is affixed to a commodity that a customer purchases, an operator of a POS (Point OF Sales) terminal reads a barcode of the commodity with a scanner. The operator inputs information concerning, a price-cut or a discount from a keyboard, a touch panel, or the like. Therefore, if the operator does not notice a price-cut or discount label, in some case, the operator sells a commodity, to which the price-cut or discount label is affixed, at a normal price.

Therefore, JP-A-2008-33640 discloses a technique for automating price-cut or discount in a POS terminal by simultaneously imaging a barcode and a price-cut or discount label with a camera and outputting a commodity code and price-cut or discount information read from imaged images to the POS terminal.

If commodities remain unsold regardless of the fact that the closing time approaches, in some case, the retail store affixes, on price-cut or discount labels already affixed to commodities, price-cut or discount labels indicating price-cut amounts or discount rates higher than price-cut amounts or discount rates indicated by the price-cut or discount labels. In that case, since a store clerk manually affixes a new price-cut or discount label on a price-cut or discount label already affixed to a commodity, in some case, the new price-cut or discount label cannot be affixed to hide the price-cut or discount label already affixed to the commodity. If the new price-cut or discount label is not affixed to hide the price-cut or discount label already affixed to the commodity, in the technique disclosed in JP-A-2008-33640, plural price-cut or discount labels are simultaneously photographed by the camera. Therefore, it cannot be discriminated which price-cut or discount label is a regular price-cut or discount label, price-cut or discount cannot be automated, and the operator has to manually input information concerning a price-cut or a discount from the keyboard or the like.

### DESCRIPTION OF THE DRAWINGS

FIG. 1 is a schematic perspective view of the configuration of a checkout lane system according to an embodiment;

FIG. 2 is a block diagram of the configuration of a code reading apparatus;

FIG. 3 is diagram of an example of a relation between a commodity and an imaging area of a camera;

FIG. 4 is a diagram of an example of a benefit indication label;

FIG. 5 is a diagram of another example of the benefit indication label;

FIG. 6 is a diagram for explaining a label characteristic table;

FIG. 7 is a diagram of image data in an imaging area imaged by a camera;

FIG. 8 is a diagram for explaining barcode data;

FIG. 9 is a diagram for explaining a benefit code;

FIG. 10 is a diagram for explaining a composite code;

FIG. 11 is a flowchart for explaining a procedure of information output processing performed by the code reading apparatus;

FIG. 12 is a diagram of an example of a relation between a commodity and an imaging area of a camera;

FIG. 13 is a diagram of image data included in the imaging area imaged by the camera;

FIG. 14 is a diagram of an example of a relation between a commodity and an imaging area of a camera; and

FIG. 15 is a diagram of image data included in the imaging area imaged by the camera.

### DETAILED DESCRIPTION

In general, according to one embodiment, a code reading apparatus includes: a photographing section configured to photograph an image; a capturing section configured to capture the photographed image; a reading section configured to detect, out of the captured image, a code symbol that represents commodity information indicating a purchase target commodity and benefit indication that represents benefit information indicating a benefit for the purchase of the commodity and read, from the detected code symbol and benefit indication, the commodity information represented by the detected code symbol and the benefit information represented by the detected benefit indication; a determining section configured to determine, if plural kinds of the benefit information are read, from benefits indicated by the plural kinds of the benefit information, a benefit granted for the purchase of the commodity indicated by the read commodity information; and an output section configured to output the read commodity information and benefit information representing the determined benefit.

In general, according to another embodiment, a code reading method includes: capturing a photographed image; detecting, out of the captured image, a code symbol that represents commodity information indicating a purchase target commodity and benefit indication that represents benefit information indicating a benefit for the purchase of the commodity and reading, from the detected code symbol and benefit indication, the commodity information represented by the detected code symbol and the benefit information represented by the detected benefit indication; determining, if plural kinds of the benefit information are read, from benefits indicated by the plural kinds of the benefit information, a benefit granted for the purchase of the commodity indicated by the read commodity information; and outputting the read commodity information and benefit information representing the determined benefit.

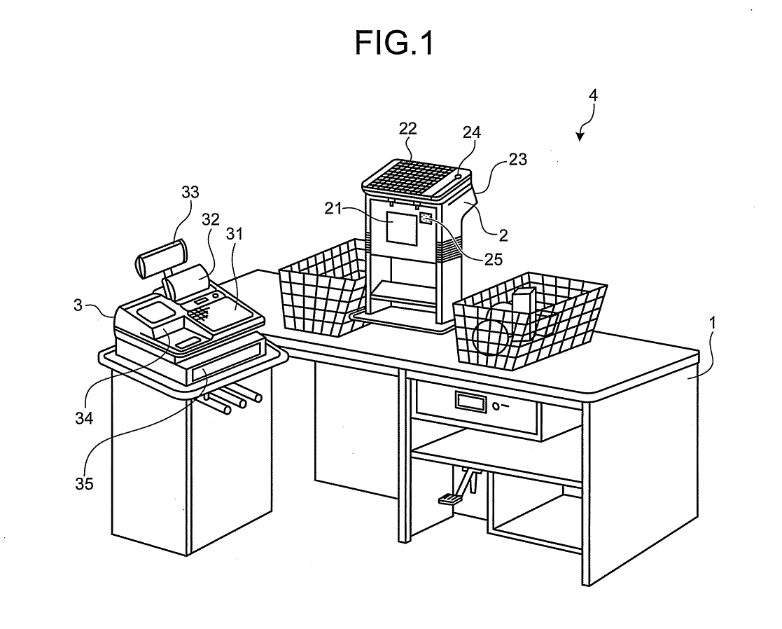

FIG. 1 is a schematic perspective view of the configuration of a checkout lane system according to an embodiment. As shown in FIG. 1, a checkout lane system 4 includes a sucker table 1 for placing a shopping basket including commodities, a code reading apparatus 2 vertically provided in substantially the center of the sucker table 1, and a POS terminal 3 connected to the code reading apparatus 2 by a not-shown transmission line to communicate with each other.

The POS (Point Of Sales) terminal 3 performs sales registration for commodities to be purchased by a customer. As shown in FIG. 1, the POS terminal 3 includes a keyboard 31, an operator display device 32, a customer display device 33, a printer 34 configured to perform receipt printing and the like, and a drawer 35 for storing cash and the like. A closing key and the like necessary for settlement of commodity prices are disposed on the keyboard 31. The POS terminal 3 includes components and functions same as those of a POS terminal typically used in the checkout lane system of this type.

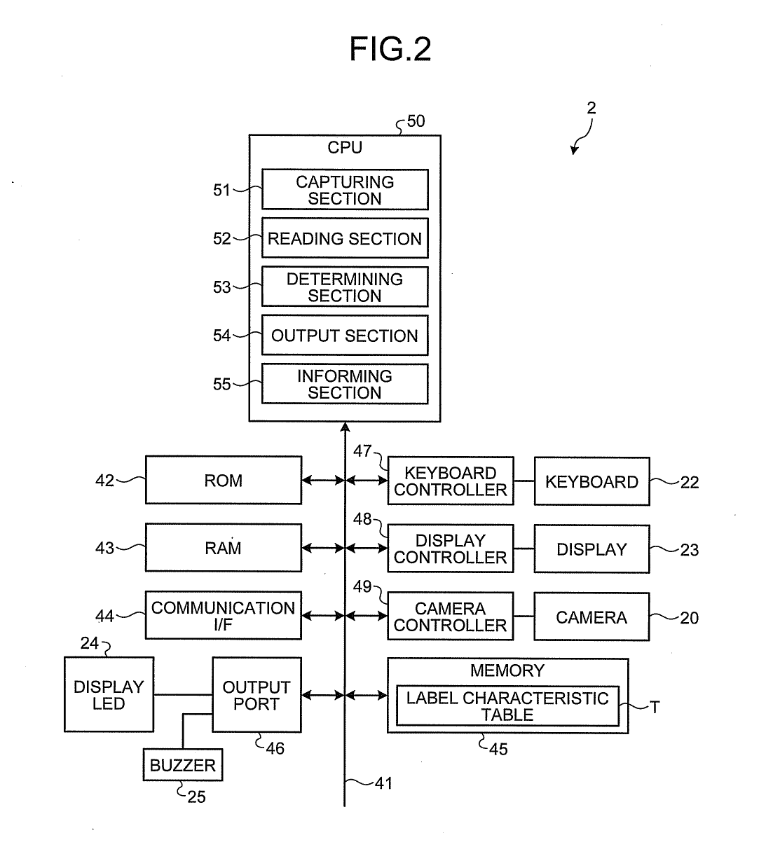

The code reading apparatus 2 reads a barcode representing commodity information such as a commodity code affixed to a purchase target commodity and indicating the commodity. The code reading apparatus 2 outputs the commodity information represented by the read barcode to the POS terminal 3. As shown in FIG. 1, the code reading apparatus 2 mainly includes a reading window 21, a keyboard 22, a display 23, a display LED 24, and a buzzer 25. The keyboard 22 receives input by various keys when registration of a commodity that cannot be registered by a barcode is performed. The display 23 displays names, prices, and the like of registered commodities to a customer. In order to inform an operator that a barcode is read, the display LED 24 is turned on when a barcode affixed to a commodity is read. In order to inform the operator that a barcode affixed to a commodity is read, the buzzer 25 gives off buzzer sound. The code reading apparatus 2 incorporates a CCD (Charge Coupled Device) camera (hereinafter referred to as camera) 20 (see FIG. 2) on the inside of a place where the reading window 21 is provided.

FIG. 2 is a block diagram of the configuration of the code reading apparatus. The code reading apparatus 2 mainly includes a CPU (Central Processing Unit) 50, a ROM (Read Only Memory) 42, a RAM (Random Access Memory) 43, a communication I/F 44, an output port 46, a keyboard controller 47, a display controller 48, a camera controller 49, and a nonvolatile memory 45. In the code reading apparatus 2, the CPU 50, the ROM 42, the RAM 43, the communication I/F 44, the output port 46, the keyboard controller 47, the display controller 48, the camera controller 49, and the nonvolatile memory 45 are connected by a bus line 41 such as an address bus or a data bus.

The CPU 50 is a control section configured to control the entire operation of the code reading apparatus 2. The ROM 42 has stored therein a computer program according to this embodiment and other computer programs and the like for controlling the operation of the CPU 50. The RAM 43 is a work area used when the CUP 50 expands the various computer programs stored by the ROM 42. The RAM 43 stores various data such as image data imaged by the camera 20.

The communication I/F 44 controls data communication with the POS terminal 3 (see FIG. 1) connected to the code reading apparatus 2 via a bus. The output port 46 outputs driving signals to the buzzer 25 and the display LED 24. The keyboard controller 47 captures a key signal from the keyboard 22. The display controller 48 controls data display on the display 23. The camera controller 49 controls an imaging operation of the camera 20.

The camera 20 is a photographing section configured to image a code symbol such as a barcode or a two-dimensional code and benefit indication such as a price-cut or discount label that represents benefit information indicating a benefit such as a price-cut or a discount granted for purchase of a commodity.

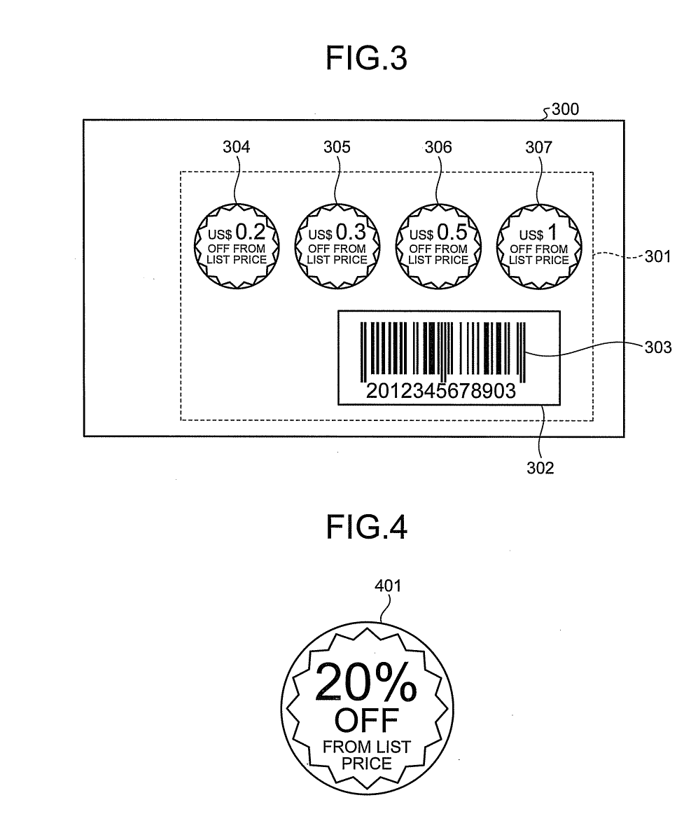

A relation between a commodity processed by the code reading apparatus 2 according to this embodiment and an imaging area of the camera 20 is explained. FIG. 3 is a diagram of an example of a relation between a commodity and an imaging area of the camera. An area surrounded by a dashed line in the figure is an imaging area 301, which is an area that the camera 20 can image in one frame. A store that sells a commodity 300 shown in FIG. 3 affixes, in addition to a barcode label 302, plural price-cut labels 304 to 307, which are an example of benefit indication, to the commodity 300. If a price of a commodity remaining unsold is further cut, a retail store or the like further affixes a price-cut label on a price-cut label already affixed to the commodity. However, usually, a store clerk manually affixes a price-cut label. Therefore, in some case, a new price-cut label cannot be affixed to hide the price-cut label already affixed to the commodity. The example shown in FIG. 3 is an example in which the new price-cut labels 305 to 307 are not affixed to hide the price-cut label 304 already affixed to the commodity 300.

The store that sells the commodity 300 affixes the barcode label 302, on which a barcode 303 is displayed, to the commodity 300. As commodity information necessary for registering sales data of the commodity 300 in the POS terminal 3, the store that sells the commodity 300 incorporates information such as a commodity code in the barcode 303. The store that sells the commodity 300 displays, in a lower part of the barcode 303, a number representing a commodity code “201234567890” incorporated in the barcode 303. Further, the store that sells the commodity 300 affixes, to the commodity 300, the price-cut labels 304 to 307 that represent benefit information “20 yen off from a list price” indicating a price-cut amount from a commodity price of the commodity 300.

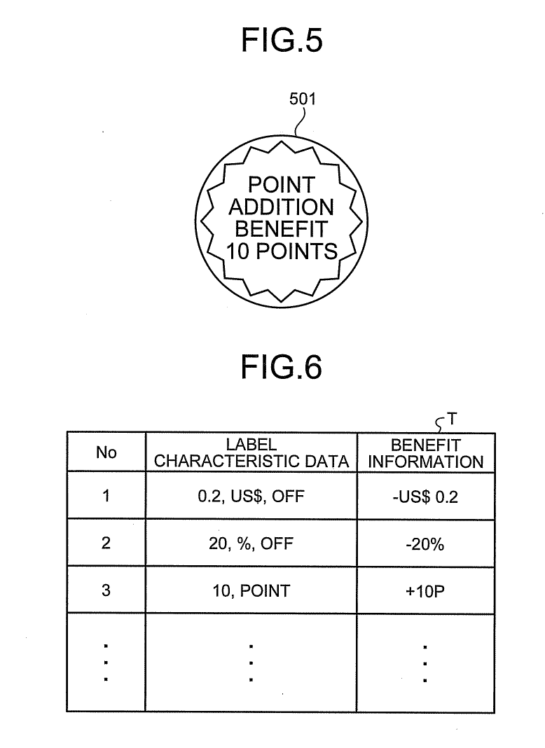

Price-cut labels affixed to the commodity 300 are not limited to the price-cut labels 304 to 307. The store that sells the commodity 300 may affix, to the commodity 300, a benefit indication label that represents benefit information indicating a benefit granted for the purchase of the commodity 300. FIGS. 4 and 5 are diagrams of other examples of the benefit indication label. The other examples of the benefit indication label include a discount label 401 representing a discount rate for the commodity 300 as shown in FIG. 4 and a point addition label 501 representing the number of points granted to a customer who purchases the commodity 300 in addition to a normal number of granted points.

The nonvolatile memory 45 has stored therein a label characteristic table T that associates characteristics of benefit indication labels and benefit information represented by the benefit indication labels.

FIG. 6 is a diagram for explaining the label characteristic table. As shown in FIG. 6, the label characteristic table T stores, in association with each other, label characteristic data indicating characteristics of characters and symbols included in the benefit indication labels and benefit information indicating benefits granted for purchase of commodities.

More specifically, the label characteristic data means information extracted from the benefit indication labels through character recognition by an OCR (Optical Character Reader) or the like. For example, the code reading apparatus 2 according to this embodiment extracts, through character recognition, information “US$, 0.2, off” as indicated by label characteristic data of No. 1 in the label characteristic table T shown in FIG. 6 from the price-cut label 304 described as “US$0.2 off from a list price” shown in FIG. 3. Similarly, the code reading apparatus 2 according to this embodiment extracts information concerning a discount and point granting “20, %, off” and “10, point” as indicated by label characteristic data of No. 2 and No. 3 shown in FIG. 6 from the discount label 401 and the point addition label 501 shown in FIG. 4.

The benefit information is information indicating a benefit such as price-cut information or point grant information indicating content of a benefit granted for purchase of a commodity. In this embodiment, benefit information indicated by an alphanumerical value is used such that the benefit information can be used in sales registration by the POS terminal 3. As shown in FIG. 6, the label characteristic table T stores benefit information “−US$0.2” indicating a price-cut of US$0.2 in association with label characteristic data “US$, 0.2, off”. The label characteristic table T stores benefit information “−20%” indicating a discount of 20% in association with label characteristic data “20, %, off”. Further, the label characteristic table T stores benefit information “+10P” indicating point addition of 10 points in association with label characteristic data “10, point”.

Characteristic functions of the code reading apparatus 2 according to this embodiment are explained below. The CPU 50 operates according to a computer program stored by the ROM 42 and expanded in the RAM 43 to function as a capturing section 51, a reading section 52, a determining section 53, an output section 54, and an informing section 55 as shown in FIG. 2.

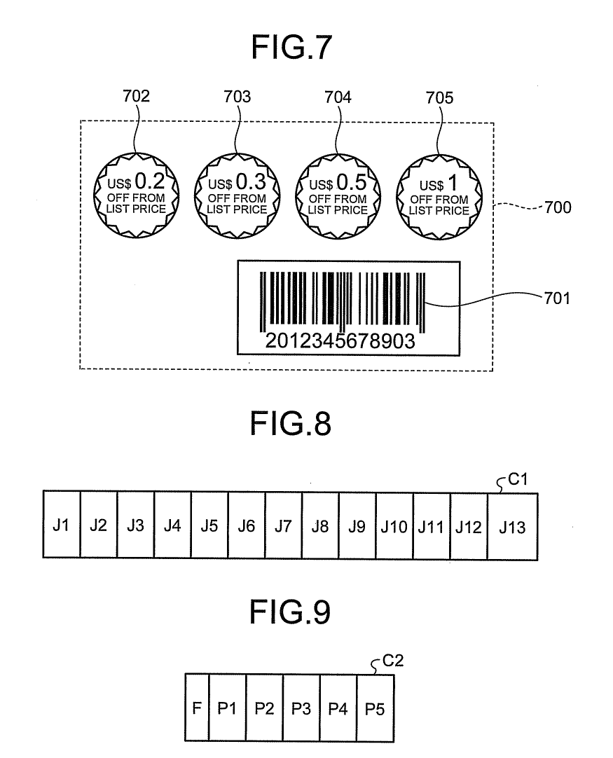

The capturing section 51 outputs an imaging ON signal to the camera controller 49 in order to cause the camera controller 49 to start the imaging operation of the camera 20. The capturing section 51 captures image data included in the imaging area 301 imaged by the camera 20. Further, the capturing section 51 stores the captured image data in an image work area of the RAM 43. FIG. 7 is a diagram of image data included in the imaging area imaged by the camera. The capturing section 51 captures image data 700 included in the imaging area 301 shown in FIG. 3. The capturing section 51 stores the captured image data 700 in the image work area of the RAM 43.

The reading section 52 detects an image 701 of the barcode 303 from the image data 700 stored in the image work area of the RAM 43 by the capturing section 51. The reading section 52 reads commodity information represented by the barcode 303 from the detected image 701 of the barcode 303.

More specifically, the reading section 52 binarizes the image data 700 of one frame stored in the image work area of the RAM 43. The reading section 52 detects whether a data area concerning a barcode is present in the binarized data. If the reading section 52 detects a data area concerning the barcode 303 in the captured image data 700, the reading section 52 decodes the barcode 303 and reads, as commodity information of the commodity 300, barcode data (a JAN code) C1 of J1 to J13 shown in FIG. 8. The barcode data C1 includes a manufacturer code, a commodity code as commodity information, a check digit and the like. The reading section 52 stores the read barcode data C1 in a barcode work area of the RAM 43.

The reading section 52 detects images 702 to 705 of the price-cut labels 304 to 307 (benefit indication labels) from the image data 700 stored in the image work area of the RAM 43 by the capturing section 51. The reading section 52 reads benefit information represented by the price-cut labels 304 to 307 from the detected images 702 to 705 of the price-cut labels 304 to 307. If the plural price-cut labels 304 to 307 are affixed to the commodity 300 as shown in FIG. 3, the reading section 52 detects the images 702 to 705 of all the price-cut labels 304 to 307. The reading section 52 reads benefit information represented by all the price-cut labels 304 to 307 from all the detected images 702 to 705 of the price-cut labels 304 to 307.

More specifically, the reading section 52 applies character recognition by an OCR (Optical Character Reader) or the like to the image data 700 of one frame stored in the image work area of the RAM 43. The reading section 52 collates characteristics of characters, pictures, symbols, or the like included in a benefit indication label and the label characteristic data (see FIG. 6) stored in the label characteristic table T. If label characteristic data having a high coinciding degree is detected, the reading section 52 determines that an image of the benefit indication label is detected from the image data 700. Subsequently, the reading section 52 reads, from the label characteristic table T, benefit information stored in association with the detected label characteristic data. The reading section 52 encodes the read benefit information and generates a benefit code C2 (see FIG. 9). The reading section 52 stores the generated benefit code C2 in a benefit code work area of the RAM 43.

FIG. 9 is a diagram for explaining a benefit code. As shown in FIG. 9, the benefit code C2 includes a flag F in which a type of a benefit is set and data P1 to P5 indicating values of benefits to be provided such as a price-cut amount, a discount rate, and the number of granted points. The flag F can represent the types of benefits as 1: discount rate, 2: price-cut amount, and 3: the number of granted points.

If plural kinds of benefit information are read by the reading section 52, the determining section 53 determines, using benefits indicated by the plural kinds of benefit information, benefits to be granted for the purchase of the commodity 300 indicated by the commodity information read by the reading section 52.

In this embodiment, if plural kinds of benefit information indicating price-cuts from the commodity price of the commodity 300 are read, the determining section 53 determines, from the price-cuts indicated by the read plural kinds of benefit information, a price-cut having a largest price-cut amount as a benefit granted for the purchase of the commodity 300. For example, if “−US$0.2”, “−US$0.3”, “−US$0.5”, and “−US$1” are read as benefit information from the images 702 to 705 of the price-cut labels 304 to 307 shown in FIG. 7, the determining section 53 determines a price-cut of US$1 indicated by “−US$1” as a benefit granted for the purchase of the commodity 300. The determining section 53 generates anew the benefit code C2 (see FIG. 9) obtained by encoding benefit information indicating the determined benefit. The determining section 53 stores the generated benefit code C2 in the benefit code work area of the RAM 43.

If the benefit code C2 generated by the reading section 52 is stored in the RAM 43, the output section 54 generates a composite code C3 obtained by combining the benefit code C2 with the barcode data C1 stored in the RAM 43 by the reading section 52. The output section 54 outputs the generated composite code C3 to the POS terminal 3. If the benefit code C2 generated anew by the determining section 53 is stored in the RAM 43, the output section 54 generates the composite code C3 obtained by combining the benefit code C2 generated anew by the determining section 53 with the barcode data C1 stored in the RAM 43 by the reading section 52. The output section 54 outputs the generated composite code C3 to the POS terminal 3.

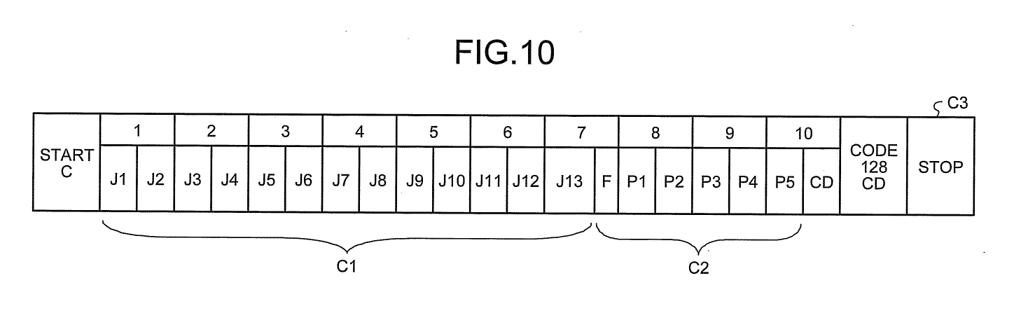

FIG. 10 is a diagram for explaining the composite code. As shown in FIG. 10, the composite code C3 begins with a start code and includes the barcode data C1, the benefit code C2, a check digit CD for the benefit code C2, and a check digit CODE128CD for the composite code C3. The composite code C3 ends with a stop code. The POS terminal 3 performs, on the basis of the composite code C3 received from the code reading apparatus 2, sales registration with the benefit indicated by the benefit code C2 granted for the purchase of the commodity 300.

As an example, if the price-cut label 304 for US$0.2 off, the price-cut label 305 for US$0.3 off, the price-cut label 306 for US$0.5 off, and the price-cut label 307 for US$1 off are affixed to the commodity 300 as shown in FIG. 3, the determining section 53 generates the benefit code C2 obtained by digitizing the benefit information “−US$1” read by the reading section 52. Therefore, the output section 54 generates the composite code C3 including the barcode data C1 corresponding to the commodity code “201234567890” and the benefit code C2 corresponding to “−US$1”. The POS terminal 3 reads a price of the commodity 300 corresponding to the barcode data C1 included in the composite code C3 referring to a commodity master or the like stored by the POS terminal 3 or a host terminal (not shown) in the store. The POS terminal 3 cuts US$1 from the read price on the basis of the benefit code C2 included in the composite code C3 and performs sales registration for the commodity 300.

If the reading section 52 reads the barcode 303, the informing section 55 outputs a barcode ON signal in order to turn on the display LED 24 to inform the operator that the barcode 303 is detected. If the output section 54 outputs the composite code C3 or the barcode data C1 to the POS terminal 3, the informing section 55 outputs a barcode OFF signal in order to turn off the display LED 24 to inform the operator that the barcode 303 is not detected.

If the output section 54 outputs the barcode data C1 to the POS terminal 3, the informing section 55 drives the buzzer 25 to give off first buzzer sound (e.g., “beep”) indicating that only the barcode label 302 is read and benefit indication labels are not read.

If the output section 54 outputs the composite data C3 to the POS terminal 3, the informing section 55 drives the buzzer 25 to give off second buzzer sound (e.g., “beep, beep”) indicating that both the barcode label 302 and benefit indication labels (the price-cut labels 304 to 307) are read.

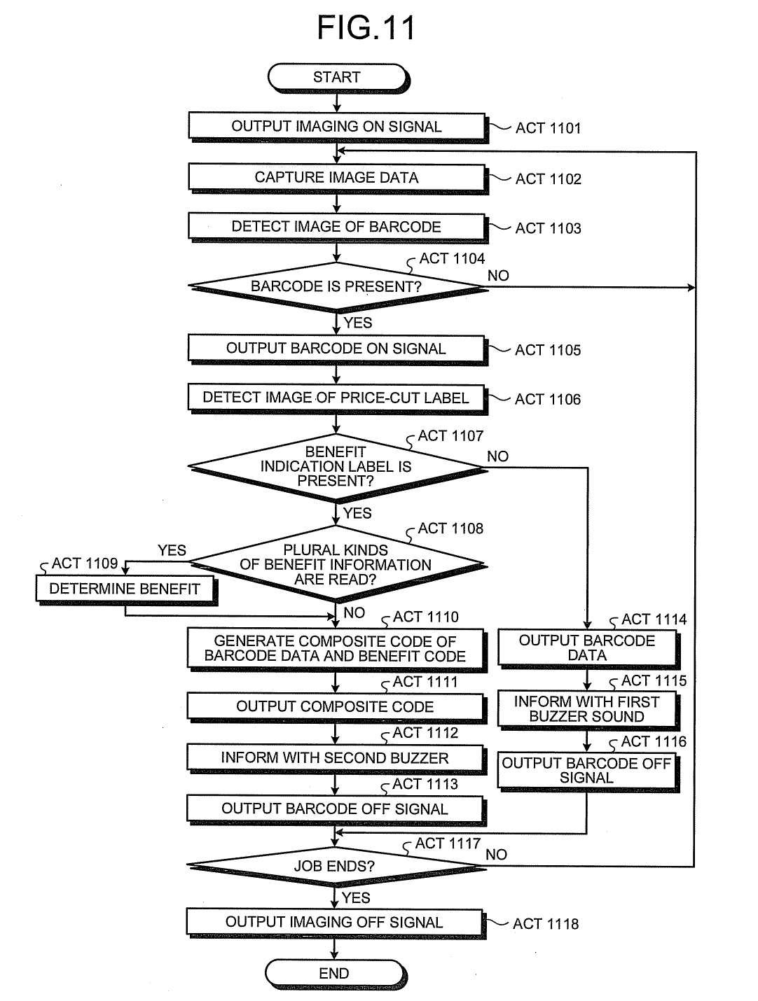

Information output processing for a commodity performed by the code reading apparatus 2 is explained below with reference to FIG. 11. FIG. 11 is a flowchart for explaining a procedure of the information output processing performed by the code reading apparatus.

If the start of a job is instructed by a command from the POS terminal 3, the CPU 50 of the code reading apparatus 2 starts information output processing. The capturing section 51 outputs an imaging ON signal to the camera controller 49 in order to start an imaging operation by the camera 20 (Act 1101). The capturing section 51 captures the image data 700 imaged by the camera 20 into the image work area of the RAM 43 (Act 1102). The reading section 52 starts detection of the image 701 of the barcode 303 (Act 1103).

The reading section 52 determines whether the image 701 of the barcode 303 is detected in Act 1103 (Act 1104). If the image 701 of the barcode 303 is not detected (No in Act 1104), the reading section 52 continues the imaging by the camera 20 (Act 1102).

If the image 701 of the barcode 303 is detected (Yes in Act 1104), the informing section 55 outputs a barcode ON signal in order to turn on the display LED 24 to inform the operator that the image 701 of the barcode 303 is detected (Act 1105).

Subsequently, the reading section 52 starts detection of the images 702 to 705 of the price-cut labels 304 to 307 from the image data 700 captured into the image work area of the RAM 43 in Act 1102 (Act 1106). The reading section 52 determines whether the images 702 to 705 of the price-cut labels 304 to 307 are detected in Act 1106 (Act 1107).

If the images 702 to 705 of the price-cut labels 304 to 307 are detected (Yes in Act 1107), the determining section 53 determines whether plural kinds of benefit information are read by the reading section 52 (Act 1108). If plural kinds of benefit information are read (Yes in Act 1108), the determining section 53 determines, using benefits indicated by the plural kinds of benefit information, benefits granted for the purchase of the commodity 300 (Act 1109).

If only one kind of benefit information is read by the label reading processing of the reading section 52 (No in Act 1108) or if a benefit granted for the purchase of the commodity 300 is determined, the output section 54 generates the composite code C3 (see FIG. 10) from the barcode data C1 stored in the barcode work area of the RAM 43 and the benefit code C2 stored in the benefit code work area (Act 1110). The output section 54 transmits and outputs the generated composite code C3 to the POS terminal 3 via the communication I/F 44 (Act 1111). The informing section 55 drives the buzzer 25 to give off the second buzzer sound (Act 1112). The informing section 55 outputs a barcode OFF signal in order to turn off the display LED 24 to inform the operator that a barcode is not read (Act 1113).

Thereafter, the CPU 50 determines whether the end of the job is instructed by a command from the POS terminal 3 (Act 1117). If the end of the job is not instructed (No in Act 1117), the CPU 50 returns to Act 1102 and repeats Acts 1102 to 1117 until sales registration for all commodities is completed. If the end of the job is instructed (Yes in Act 1117), the CPU 50 outputs an imaging OFF signal to the camera controller 49 in order to end the imaging operation by the camera 20 (Act 1118).

On the other hand, if the images 702 to 705 of the price-cut labels 304 to 307 are not detected (No in Act 1107), the output section 54 transmits and outputs the barcode data C1 stored in the barcode work area of the RAM 43 to the POS terminal 3 via the communication I/F 44 (Act 1114). The informing section 55 drives the buzzer 25 to give off the first buzzer sound (Act 1115). The informing section 55 outputs a barcode OFF signal in order to turn off the display LED to inform the operator that the image 701 of the barcode 303 is not read (Act 1116). Thereafter, the CPU 50 shifts to Act 1117.

As explained above, with the code reading apparatus 2 according to this embodiment, if plural benefit indication labels are affixed to the commodity 300 and plural kinds of benefit information represented by the plural benefit indication labels are read, a benefit granted for the purchase of the commodity 300 is determined using benefits indicated by the plural kinds of benefit information. Consequently, even if the plural benefit indication labels are affixed to the commodity 300, price-cut or discount can be automated. Therefore, it is possible to reduce a work load on the operator due to price-cut or discount.

Another embodiment is an example in which, if plural benefit indication labels that represent benefit information indicating price-cut amounts or discount rates for a commodity are affixed to the commodity and plural kinds of benefit information represented by the plural kinds of benefit indication labels are read, a total of price-cut amounts or discount rates indicated by the plural kinds of benefit information is determined as a benefit granted for purchase of the commodity. In the following explanation, explanation of similarities to the code reading apparatus 2 explained above is omitted and only differences from the code reading apparatus 2 explained above are explained.

In this embodiment, if plural kinds of benefit information indicating price-cuts from a commodity price of the commodity 300 are read by the reading section 52, the determining section 53 determines, as a benefit granted for purchase of the commodity 300, a total of the price-cuts indicated by the read plural kinds of benefit information. For example, if “−US$0.2”, “−US$0.3”, “−US$0.5”, and “−US$1” are read as benefit information from the images 702 to 705 of the price-cut labels 304 to 307 shown in FIG. 7, the determining section 53 determines, as a benefit granted for the purchase of the commodity 300, a price-cut of US$2, which is a total of “−US$0.2”, “−US$0.3”, “−US$0.5”, and “−US$1”.

As explained above, with the code reading apparatus 2 according to this embodiment, if plural kinds of benefit information indicating price-cuts or discounts from the commodity price of the commodity 300 are read by the reading section 52, a total of the price-cuts or discounts indicated by the read plural kinds of benefit information is determined as a benefit granted for the purchase of the commodity 300. Consequently, even if plural benefit indication labels are affixed to the commodity 300, it is possible to automatically perform price-cut or discount processing. Therefore, it is possible to reduce a work load on an operator due to the price-cut or discount processing.

Still another embodiment is an example in which, if plural benefit indication labels that represent benefit information indicating prices of a price-cut or discounted commodity are affixed to the commodity and plural kinds of benefit information represented by the plural benefit indication labels are read, a lowest price of the commodity among prices of the commodity indicated by the plural kinds of benefit information is determined as a benefit granted for purchase of the commodity. In the following explanation, explanation of similarities to the code reading apparatus 2 explained above is omitted and only differences from the code reading apparatus 2 explained above are explained.

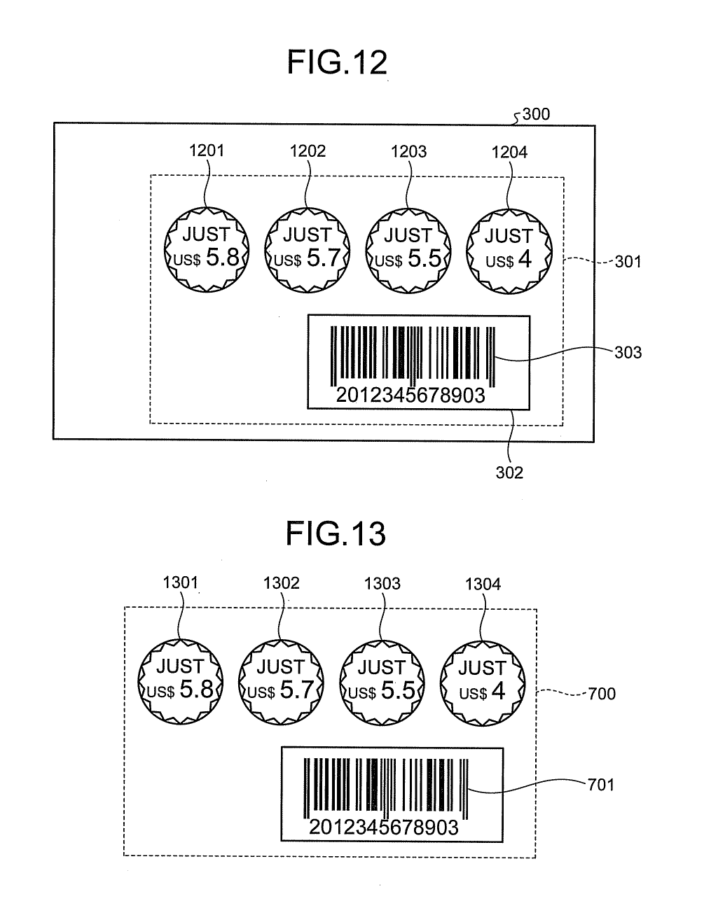

FIG. 12 is a diagram of an example of a relation between a commodity and an imaging area of a camera. In this embodiment, a store that sells the commodity 300 affixes, in addition to the barcode label 302, commodity price labels 1201 to 1204 that represent benefit information indicating prices of a price-cut or discounted commodity (hereinafter referred to as just prices) to the commodity 300.

FIG. 13 is a diagram of image data included in the imaging area imaged by the camera. The capturing section 51 captures the image data 700 included in the imaging area 301 shown in FIG. 12. The capturing section 51 stores the captured image data 700 in the image work area of the RAM 43.

The reading section 52 detects images 1301 to 1304 of the commodity price labels 1201 to 1204 from the image data 700 stored in the image work area of the RAM 43 by the capturing section 51. The reading section 52 reads benefit information represented by the detected images 1301 to 1304 of the commodity price labels 1201 to 1204. If plural commodity price labels 1201 to 1204 are affixed to the commodity 300 as shown in FIG. 12, the reading section 52 detects all the images 1301 to 1304 of the commodity price labels 1201 to 1204. The reading section 52 reads benefit information represented by all the detected images 1301 to 1304 of the commodity price labels 1201 to 1204.

If plural kinds of benefit information indicating just prices of the commodity 300 are read, the determining section 53 determines, as a benefit granted for purchase of the commodity, a lowest just price among the just prices indicated by the read plural kinds of benefit information. For example, if “US$5.8”, “US$5.7”, “US$5.5”, and “US$4” are read as benefit information from the images 1301 to 1304 of the commodity price labels 1201 to 1204 shown in FIG. 12, the determining section 53 determines, as a benefit granted for the purchase of the commodity 300, a just price US$4 indicated by “US$4”.

As explained above, with the code reading apparatus 2 according to this embodiment, if the plural commodity price labels 1201 to 1204 that represent benefit information indicating just pries are affixed to the commodity 300 and plural kinds of benefit information represented by the plural commodity price labels 1201 to 1204 are read, a lowest just price among just prices indicated by the plural kinds of benefit information is determined as a benefit granted for the purchase of the commodity 300. Consequently, even if the plural commodity price labels 1201 to 1204 are affixed to the commodity 300, it is possible to automatically perform price-cut or discount processing. Therefore, it is possible to reduce a work load on an operator due to the price-cut or discount processing.

Still another embodiment is an example in which, if plural benefit indication labels are affixed to a commodity and plural kinds of benefit information represented by the plural benefit indication labels are read, among the plural kinds of benefit information, a benefit indicated by benefit information read from a benefit indication label having a high-priority shape is determined as a benefit granted for purchase of the commodity. In the following explanation, explanation of similarities to the code reading apparatus 2 explained above is omitted and only differences from the code reading apparatus 2 explained above are explained.

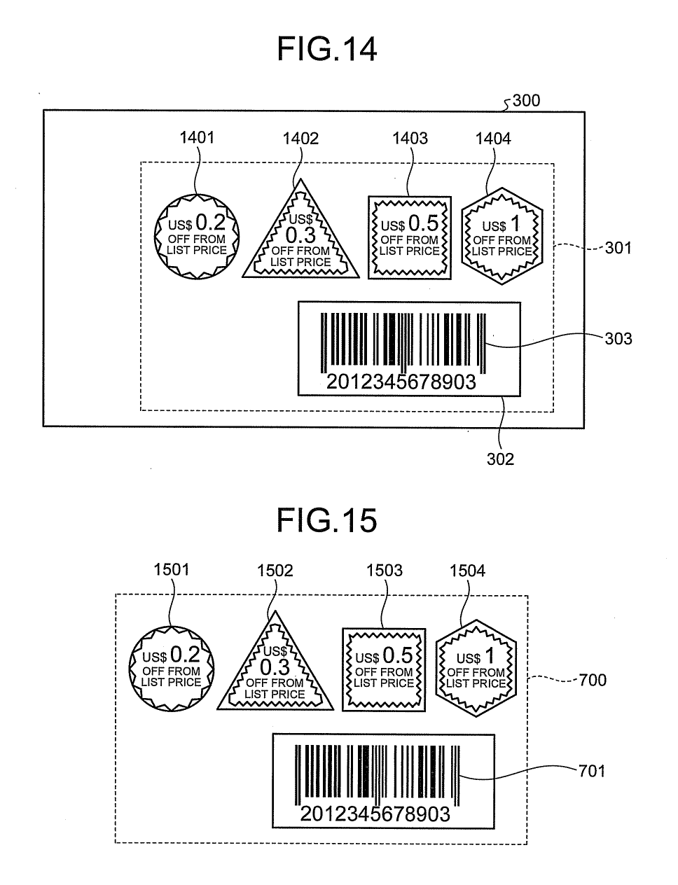

FIG. 14 is a diagram of an example of a relation between a commodity and an imaging area of a camera. In this embodiment, a store that sells the commodity 300 affixes, in addition to the barcode label 302, price-cut labels 1401 to 1404 that represent benefit information indicating price-cuts for the commodity 300 to be purchased and respectively have different shapes (e.g., a circle, a triangle, a square, and a hexagon) to the commodity 300.

FIG. 15 is a diagram of image data included in the imaging area imaged by the camera. The capturing section 51 captures the image data 700 included in the imaging area 301 shown in FIG. 14. The capturing section 51 stores the captured image data 700 in the image work area of the RAM 43.

The reading section 52 detects images 1501 to 1504 of the price-cut labels 1401 to 1404 from the image data 700 stored in the image work area of the RAM 43 by the capturing section 51. The reading section 52 reads benefit information represented by the detected images 1501 to 1504 of the discount labels 1401 to 1404 and the shapes of the respective price-cut labels 1401 to 1404. If plural price-cut labels 1401 to 1404 are affixed to the commodity 300 as shown in FIG. 14, the reading section 52 detects all the images 1501 to 1504 of the price-cut labels 1401 to 1404. The reading section 52 reads benefit information represented by all the detected images 1501 to 1504 of the price-cut labels 1401 to 1404 and all the shapes of the price-cut labels 1401 to 1404.

If plural kinds of benefit information indicating price-cuts from the commodity 300 are read, the determining section 53 determines, from the price-cuts indicated by the read plural kinds of benefit information, as a benefit granted for purchase of the commodity 300, a price-cut indicated by benefit information read from an image of a price-cut label having a highest priority shape set in advance. For example, if “−US$0.2”, “−US$0.3”, “−US$0.5”, and “−US$1” are read as benefit information from the images 1501 to 1504 of the price-cut labels 1401 to 1404 shown in FIG. 15, the determining section 53 determines, as a benefit granted for the purchase of the commodity 300, a price-cut of US$1 indicated by “−US$1” read from the image 1504 of the price-cut label 1404 having a highest priority shape (the hexagon) set in advance.

As explained above, with the code reading apparatus 2 according to this embodiment, if the plural price-cut labels 1401 to 1404 are affixed to the commodity 300 and plural kinds of benefit information represented by the plural price-cut labels 1401 to 1404 are read, a benefit indicated by benefit information read from a price-cut label having a highest priority shape among the plural kinds of benefit information is determined as a benefit granted for the purchase of the commodity 300. Consequently, even if the plural price-cut labels 1401 to 1404 are affixed to the commodity 300, price-cut or discount can be automated. Therefore, it is possible to reduce a work load on an operator due to price-cut or discount processing.

A computer program executed by the code reading apparatus according to the embodiments is provided while being incorporated in the ROM 42 or the like in advance. However, the computer program executed by the code reading apparatus 2 according to the embodiments may be provided while being recorded in a computer-readable recording medium such as a CR-ROM, a flexible disk (FD), a CD-R, or a DVD (Digital Versatile Disk) as a file of an installable format or an executable format.

Further, the computer program executed by the code reading apparatus 2 according to the embodiments may be stored on a computer connected to a network such as the Internet and provided by being downloaded through the network. The computer program executed by the code reading apparatus 2 according to the embodiments may be provided or distributed through the network such as the Internet.

Further effects and modifications can be easily derived by those skilled in the art. Therefore, wider aspects of the present invention are not limited to the specific details and the representative embodiments shown and described herein.

Therefore, various changes are possible without departing from the spirit or the scope of the general concept of the invention defined by the appended claims and equivalents of the claims.

What is claimed is:

1. A code reading apparatus comprising:
a photographing section configured to photograph an image;
a capturing section configured to capture the photographed image;
a reading section configured to detect, out of the captured image, a code symbol that represents commodity information indicating a purchase target commodity and benefit indication that represents benefit information indicating a benefit for the purchase of the commodity and read, from the detected code symbol and benefit indication, the commodity information represented by the detected code symbol and the benefit information represented by the detected benefit indication;
a determining section configured to determine, if plural kinds of the benefit information are read, from benefits indicated by the plural kinds of the benefit information, a benefit granted for the purchase of the commodity indicated by the read commodity information; and
an output section configured to output the read commodity information and benefit information representing the determined benefit.

2. The apparatus according to claim 1, wherein
the benefit information indicates a price-cut amount or a discount rate of the commodity, and
the determining section determines, as the benefit for the purchase of the commodity indicated by the read commodity information, a largest price-cut amount or discount rate among price-cut amounts or discount rates indicated by the plural kinds of the benefit information.

3. The apparatus according to claim 1, wherein
the benefit information indicates a price-cut amount or a discount rate of the commodity, and
the determining section determines, as the benefit for the purchase of the commodity indicated by the read commodity information, a total of price-cut amounts or discount rates indicated by the plural kinds of the benefit information.

4. The apparatus according to claim 1, wherein
the benefit information indicates a price of the price-cut or discounted commodity, and
the determining section determines, as the benefit for the purchase of the commodity indicated by the read commodity information, a lowest price of the commodity among prices of the commodity indicated by the plural kinds of the benefit information.

5. The apparatus according to claim 1, wherein
the reading section further reads a shape of the detected benefit indication from the detected benefit indication, and
the determining section determines, as the benefit for the purchase of the commodity indicated by the read commodity information, a benefit indicated by benefit information read from the benefit indication having a highest priority shape.

6. The apparatus according to claim 1, wherein the output section outputs a composite code obtained by combining a commodity code obtained by encoding the read commodity information and a benefit code obtained by encoding the read benefit information.

7. A code reading method comprising:
capturing a photographed image;
detecting, out of the captured image, a code symbol that represents commodity information indicating a purchase target commodity and benefit indication that represents benefit information indicating a benefit for the purchase of the commodity and reading, from the detected code symbol and benefit indication, the commodity information represented by the detected code symbol and the benefit information represented by the detected benefit indication;
determining, if plural kinds of the benefit information are read, from benefits indicated by the plural kinds of the benefit information, a benefit granted for the purchase of the commodity indicated by the read commodity information; and
outputting the read commodity information and benefit information representing the determined benefit.

8. The method according to claim 7, wherein
the benefit information indicates a price-cut amount or a discount rate of the commodity, and
the method further comprises determining, as the benefit for the purchase of the commodity indicated by the read commodity information, a largest price-cut amount or discount rate among price-cut amounts or discount rates indicated by the plural kinds of the benefit information.

9. The method according to claim 7, wherein
the benefit information indicates a price-cut amount or a discount rate of the commodity, and
the method further comprises determining, as the benefit for the purchase of the commodity indicated by the read commodity information, a total of price-cut amounts or discount rates indicated by the plural kinds of the benefit information.

10. The method according to claim 7, wherein
the benefit information indicates a price of the price-cut or discounted commodity, and
the method further comprises determining, as the benefit for the purchase of the commodity indicated by the read commodity information, a lowest price of the commodity among prices of the commodity indicated by the plural kinds of the benefit information.

11. The method according to claim 7, further comprising:
reading a shape of the detected benefit indication from the detected benefit indication; and
determining, as the benefit for the purchase of the commodity indicated by the read commodity information, a benefit indicated by benefit information read from the benefit indication having a highest priority shape.

12. The method according to claim 7, further comprising outputting a composite code obtained by combining a commodity code obtained by encoding the read commodity information and a benefit code obtained by encoding the read benefit information.
